(19) United States
(12) Patent Application Publication
(10) Pub. No.: US 2015/0115591 A1
(43) Pub. Date: Apr. 30, 2015

(54) Magnetic Stripe/Smart Card Integrated with Re-sealable Booklet

(71) Applicant: Stephen Arthur Crossman, Prescott (CA)

(72) Inventor: Stephen Arthur Crossman, Prescott (CA)

(21) Appl. No.: 14/523,553

(22) Filed: Oct. 24, 2014

Related U.S. Application Data
(60) Provisional application No. 61/895,041, filed on Oct. 24, 2013.

(51) Int. Cl. B42D 3/12

(52) U.S. Cl. CPC B42D 3/12
USPC 281/36

(57) ABSTRACT

A data-readable card integrated with re-sealable booklet includes a front cover, a data-readable card, and a booklet. The booklet is positioned in between the front cover and the data-readable card in such a way that the front cover is adjacently connected across the booklet while the data-readable card is adjacently connected across the booklet opposite of the front cover. The data-readable card is hingedly connected to the front cover along a booklet spine of the booklet so that the present invention can be selectively configured in between an opened position and a closed position by the users. The opened position allows the users to access the booklet while the closed position permits the users to utilize the data-readable card.

The current application claims a priority to the U.S. Provisional Patent application Ser. No. 61/895,041 filed on Oct. 24, 2013.

### FIELD OF THE INVENTION

The present invention relates generally to an apparatus for presenting printed matter in a booklet. More particularly, the present invention is a data-readable card integrated with a re-sealable booklet.

### BACKGROUND OF THE INVENTION

We use smart cards and cards with magnetic stripes on them every day without even thinking about it. The technology has been with us for many years, but for the most part, the visual presentation of the actual cards aside from improved graphic quality has remained the same since they were first introduced. The first use of magnetic stripes on cards was in the early 1960's. London Transit Authority installed a magnetic stripe system in the London Underground (UK). By the late 1960's BART (Bay Area Rapid Transit) (USA) had installed a paper based ticket the same size as the credit cards we use today. This system used a stored value on the magnetic stripe which was read and rewritten every time the card was used. Credit cards were first issued in 1951, but it was not until the establishment of standards in 1970 that the magnetic stripe became a factor in the use of the cards. Today, financial cards all follow the ISO standards to ensure read reliability world-wide and along with transit cards constitute the largest users of magnetic stripe cards.

Everyone uses magnetic stripes. The most visible use is your bank (credit, debit, and ATM) cards, but these are not the only places. Take a look at your Airline Ticket and Boarding pass (ATB) the next time you travel. Many of these are now including magnetic stripes on the cards. Other places include your phone card, your transit (bus or train) ticket, and even your parking lot ticket. Smart cards are credit card-sized plastic cards that contain relatively large amounts of information in an imbedded micro-chip. Smart cards differ from magnetic stripe cards in two ways: the amount of information that can be stored is much greater, and some smart cards can be reprogrammed to add, delete or rearrange data. There are several terms used to identify cards with integrated circuits embedded in them. The terms “chip card,” “integrated circuit card”, and “smart card” really all refer to the same thing. Smart cards are not new, the first patent was filed in France in 1974 and the first cards were used in France in 1982. The technology was rapidly accepted in Europe because the high cost of telecommunications made on-line verification of transactions very expensive. The smart card provided the mechanism to move that verification off line, reducing the cost without sacrificing any of the security.

There are many smart cards in use today throughout the world. In 1993 approximately 330 million cards were produced by the major manufacturers. Of this number only about 12% were true “smart cards”, the rest were simple memory cards. This was projected to grow to approximately 580 million cards in 1995 (about 10% being “smart”) and 990 million in 1996 (approx. 10% “smart”). Of the cards issued in 1993 approx. 260 million were used in phone systems; 25 million in health applications; and 23 million in banking. The rest were used in various small projects and trials.

ICMA Élan Awards—Reflecting the Newest Innovations in Cards

Every year, the prestigious ICMA Élan Awards cast a spotlight on the best of the best in the global card industry, honoring world-class achievements in card design and technological innovation. Widely acknowledged as the most renowned showcase for card excellence, the coveted Élan Awards distinguish ICMA member manufacturers and suppliers before peers and customers as industry leaders. The Élan Awards celebrate ICMA members' commitment to the design quality and technical advances that drive the future of the global card industry, which is ultimately the true winner in this acclaimed program.

Looking back over the past two year winners, it should be noted that all 78 winners of the Elan Awards comprised of standard credit cards with varying differences in either print graphics or quality or a subtle oddity in the shape of the card. In no case was there ever a feature that included a re-sealable booklet that when opened, revealed a printed catalog or fold out panels, a feature unique to the present invention. Recent developments in trying to achieve a larger banner to include instructions, etc. have been directed primarily in the packaging of the cards. Unfortunately however, once a card is removed from the packaging, any advertising message or instructions are quickly discarded into the trash losing any usefulness as a reference or marketing vehicle when the client pulls the card from their wallet or purse to make a purchase.

It is therefore an object of the present invention to introduce a magnetic stripe and or a smart card integrally packaged with presentable printed media. The printed media comprises a booklet which may include but is not limited to text, 2D images, and holographic images. The present invention provides the user a package of printed media attached to a card comprising stored data accessible by a magnetic stripe or micro-chip as the stored data may include, but is not limited to, monetary value and access codes.

### BRIEF DESCRIPTION OF THE DRAWINGS

FIG. 1 is a front perspective view of the preferred embodiment of the present invention, wherein the present invention is at the opened position.

FIG. 2 is a back perspective view of the preferred embodiment of the present invention, wherein the present invention is at the opened position.

FIG. 3 is an exploded view of the preferred embodiment of the present invention, wherein the booklet includes a plurality of pages as the at least one intermediate page.

FIG. 4 is an exploded view of the alternative embodiment of the present invention, wherein the booklet includes a foldout page as the at least one intermediate page.

FIG. 5 is a front perspective view of the preferred embodiment of the present invention, wherein the present invention is at the closed position.

FIG. 6 is a back view of the present invention, showing the integrated magnetic strip.

FIG. 7 is a back view of the present invention, showing the embedded micro-chip.

### DETAIL DESCRIPTIONS OF THE INVENTION

All illustrations of the drawings are for the purpose of describing selected versions of the present invention and are not intended to limit the scope of the present invention.

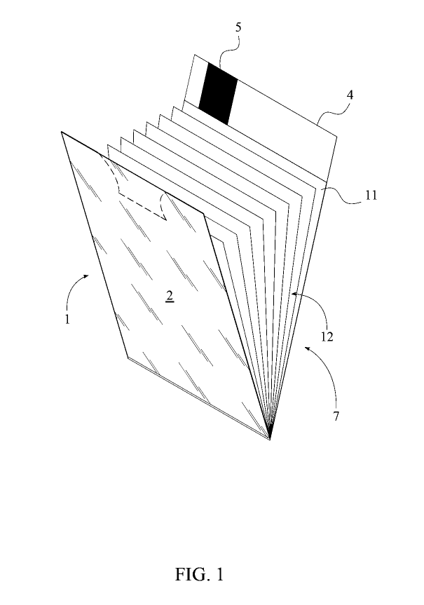

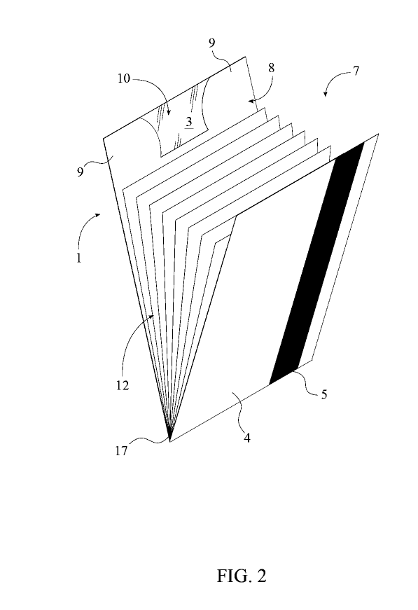

The present invention is a data-readable card integrated with a re-sealable booklet so that the present invention is able to enhance the usage process of the traditional data-readable cards. The present invention functions similar to the traditional data-readable cards as the traditional data-readable cards can include, but not limited to, credit cards, debit cards, access cards, identification cards, and gift cards. In reference to FIG. 1 and FIG. 2, the present invention comprises a front cover 1, a data-readable card 4, and a booklet 7 as the main components of the present invention. As for the general configuration of the present invention, the booklet 7 is positioned in between the front cover 1 and the data-readable card 4 in such a way that the front cover 1 is adjacently connected across the booklet 7 while the data-readable card 4 is adjacently connected across the booklet 7 opposite of the front cover 1. The data-readable card 4 is hingedly connected to the front cover 1 along a booklet spine 17 of the booklet 7 so that the present invention can be selectively configured in between an opened position and a closed position by the users.

In reference to FIG. 1 and FIG. 2, the booklet 7 of the present invention can be accessed when the present invention is at the opened position and comprises a front page 8, a rear page 11, and at least one intermediate page 12. The at least one intermediate page 12 is positioned in between the front page 8 and the rear page 11 as the front page 8, the at least one intermediate page 12, and the rear page 11 are hingedly connected to each other by the booklet spine 17. The booklet spine 17 functions as the pivot point of the booklet 7 so that the users can access at least one intermediate page 12 by turning over the front page 8 or the rear page 11. The at least one intermediate page 12 may comprise printed media including, but not limited to, regular print, scratch & win and/or scratch & sniff lottery tickets, advertisements, coupons which may give the present invention added value, plastic magnets, stickers, radio frequency (RF) identification information, school pass information, and mapping information such as a layout of a campus. The at least one intermediate page 12 can further utilized as telephone card, a hotel door access card, an insurance card, subscription/membership card, and a business card. The ability to incorporate booklet 7 as an integral part of the present invention permits a world of opportunity for marketers looking to engage their customers.

Examples include:
1. Retailers who issue gift cards can include special offers, they can promote and lead the consumer to their online shopping page, they can build their databases by inviting clients to participate in online games after first completing a registration process, retailers can sell advertisement space in their booklets to their vendors, influencing their purchasing decision at the precise time they are ready to make a buy.
2. Cards used as an electronic key to unlock a hotel door could easily contain added value coupons and vouchers from local restaurants and retailers. Hotels surrounding popular events or theme parks could include special admission discounts adding value to their product.
3. Membership Cards could contain special discounts or dollars off products available in the club house or in-store merchants.
4. Restaurant and fast food outlets can enjoy the benefits of presenting special food discount offers
5. Phone Card could include extended information outlining their services and include special numbers of contact.
6. Transit companies could incorporate maps of their transit routes in addition to special discounts to specific merchants along the routes.
7. Parking pass vouchers at airports or hospitals could contain detailed information and schematics showing how to get to the most favored areas
8. University Passes could include a layout of the University along with discounts from neighboring retailers.

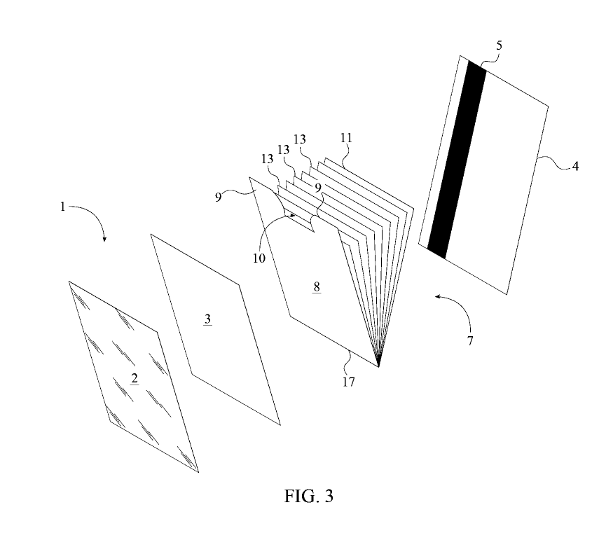

The front page 8 that is positioned atop the at least one intermediate page 12 and the rear page 11 comprises a pair of tabs 9 and an indentation 10. The pair of tabs 9 is oppositely positioned from the booklet spine 17 across the front page 8 in such a way that the pair of tabs 9 and the booklet 7 spin are positioned parallel to each other. The pair of tabs 9 extends beyond full length of the rear page 11 and the at least one intermediate page 12 so that the pair of tabs 9 can be offset from the rear page 11 and the at least one intermediate page 12. The indentation 10 is positioned in between the pair of tabs 9 as the open edge in between the pair of tabs 9 is recognized as the indentation 10. In a preferred embodiment of the present invention, the at least one intermediate page 12 can be a plurality of pages 13 as shown in FIG. 3. More specifically, each of the plurality of pages 13 is adjacently connected to each other along the booklet spine 17 so that the users are able to flip through each of the plurality of pages 13.

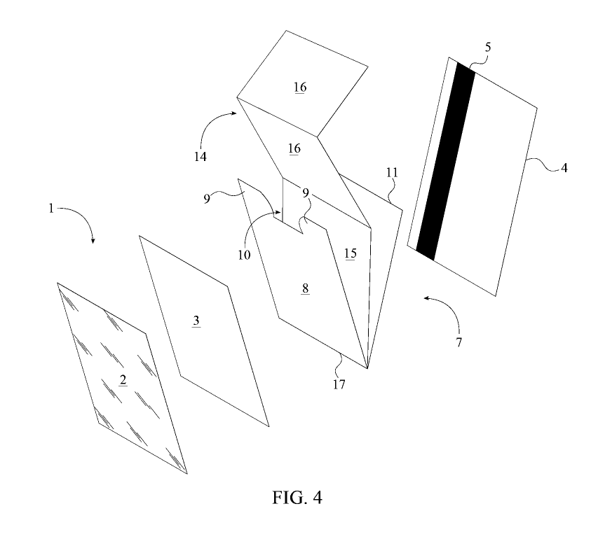

In an alternative embodiment of the present invention, the at least one intermediate page 12 can be a foldout page 14 that comprises an inner page 15 and at least one outer page 16 as shown in FIG. 4. More specifically, the inner page 15 is adjacently connected along the booklet spine 17 while the at least one outer page 16 is foldably and adjacently connected to the inner page 15. The at least one outer page 16 and the inner page 15 can additionally include a plurality of secondary panels as the secondary panels are separated through a plurality of creases. For example, a singular sheet can be folded through the plurality of creases while one of the section is connected to the booklet spine 17 as the inner page 15, and the rest of sections are either connected to the inner page 15 and/or to each other as the at least one outer page 16.

The front cover 1 that is adjacently connected across the booklet 7 comprises a front adhesive layer 3 and a front protective layer 2. The front adhesive layer 3, which permanently connects the front protective layer 2 to the front page 8, is superimposed upon the front page 8 opposite of the at least one intermediate page 12 so that the front protective layer 2 can be superimposed upon the front adhesive layer 3 opposite from the front page 8. In the preferred embodiment, the front adhesive layer 3 preferably comprises a pressure sensitive adhesive, whereupon applied pressure determines the degree of bond or strength of adherence to the adherent. The front protective layer 2 is made from a flexible and semi-transparent material, allowing for the booklet 7 to be viewable and thereby identified through the semi-transparent material. The flexibility of the front protective layer 2 allows the present invention to be stored in a wallet or a pocket without compromising the structural integrity of the present invention. Additionally, the front adhesive layer 3 and the front protective layer 2 are fully extended across the front page 8 so that the front adhesive layer 3 and the front protective layer 2 are able to fully cover the front page 8 from the booklet spine 17 to the pair of tabs 9. As a result, a portion of the front adhesive layer 3 is exposed through the indentation 10 and faces the data-readable card 4, wherein the exposed area of the front adhesive layer 3 allows the present invention to maintain its closed position within the present invention.

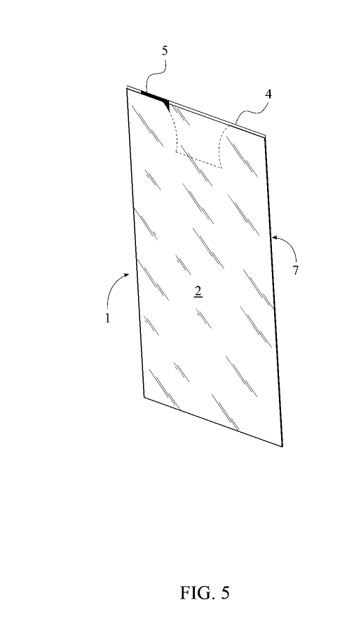

The data-readable card 4 is superimposed upon the rear page 11 and offsets from the rear page 11 as the data-readable card 4 has the extract length as the front cover 1. More specifically, the data-readable card 4 is oppositely positioned from the at least one intermediate page 12 and hingedly connected to the front adhesive layer 3 along the booklet spine 17. In reference to FIG. 1 and FIG. 5, the hinged-connection between the data-readable card 4 and the front cover 1 allows the present invention to configure in between the opened position and the closed position.

The hinged-connection between the front cover 1 and the data-readable card 4 further comprises a layer spine, which serves as a binding strip to the front cover 1 and the data-readable card 4 of the present invention. The edges, which are positioned adjacently and in parallel relations to the length of the booklet spine 17, of the front protective layer 2, the front adhesive layer 3, and the data-readable card 4, are hereinafter referred to as spinal edges, which when assembled serves as the binding strip. The length of the spinal edge of the front protective layer 2 is positioned along the length of the spinal edge of the front adhesive layer 3. The length of the spinal edge of the front adhesive layer 3 is positioned along the length of the spinal edge of the data-readable card 4 and connected to each other by the adhesive properties of the front adhesive layer 3.

The opened position of the present invention allows the booklet 7 to be accessed by the users while the closed position enables the users to use the present invention. More specifically, the exposed area of the front adhesive layer 3 attaches the front cover 1 to the rear side of the data-readable card 4 so that the present invention is able to position within the closed position. In order for the present invention to be at the opened position, the users need to separate the front cover 1 from the data-readable card 4 by utilizing the pair of tabs 9 and the indentation 10. Upon the front cover 1 being released, the front adhesive layer 3 may be adhered to the rear side of the data-readable card 4.

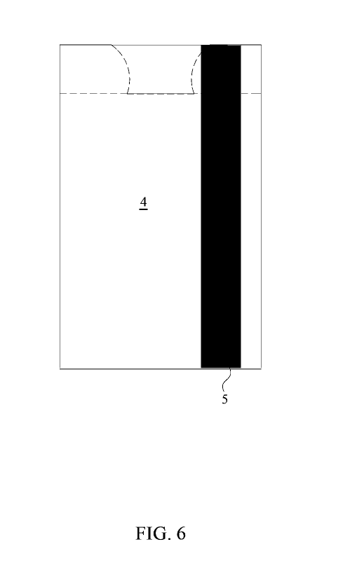

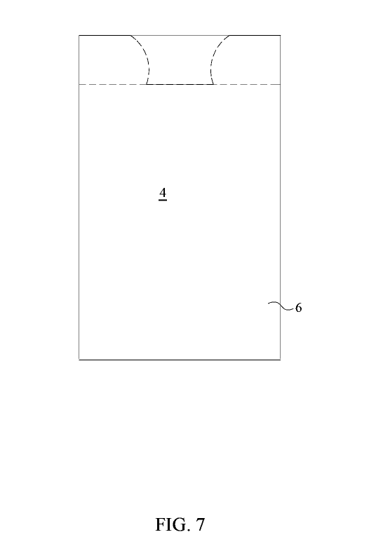

The data-readable card 4 comprises an integrated magnetic strip 5 or a micro-chip 6 as the readable medium so that information can be transferred into the respective electronic device from the present invention. In reference to FIG. 1 and FIG. 6, the, the integrated magnetic strip 5 is positioned along the data-readable card 4 and positioned opposite of the rear page 11. The data-readable card 4 is made from a flexible material such as plastic so that the flexibility of the data-readable card 4 allows the present invention to be stored in a wallet or a pocket without compromising the structural integrity of the present invention. Additionally, the magnetic strip 5 can be integrated into either the rear side or the front side of the data-readable card 4 where one does not precede the other. In reference to FIG. 7, the micro-chip 6 is embedded within the data-readable card 4. The data stored within the micro-chip 6 or the integrated magnetic strip 5 may include, but is not limited to, monetary values, monetary discounts, a key or access code, identification information, and any other similar information.

Although the invention has been explained in relation to its preferred embodiment, it is to be understood that many other possible modifications and variations can be made without departing from the spirit and scope of the invention as hereinafter claimed.

What is claimed is:

1. A data-readable card integrated with re-sealable booklet comprises:
a front cover;
a data-readable card;
a booklet;
the front cover comprises a front protective layer and a front adhesive layer;
the booklet comprises a front page, a rear page, at least one intermediate page, and a booklet spine;
the booklet being positioned in between the front cover and the data-readable card;
the front cover being adjacently connected across the booklet;
the data-readable card being adjacently connected across the booklet opposite of the front cover; and
the data-readable card being hingedly connected to the front cover along the booklet spine.

2. The data-readable card integrated with re-sealable booklet as claimed in claim 1 comprises:
the at least one intermediate page being positioned in between the front page and the rear page; and
the front page, the at least one intermediate page, and the rear page being hingedly connected to each other by the booklet spine.

3. The data-readable card integrated with re-sealable booklet as claimed in claim 2 comprises:
the at least one intermediate page being a plurality of pages; and
each of the plurality of pages being adjacently connected along the booklet spine.

4. The data-readable card integrated with re-sealable booklet as claimed in claim 2 comprises:
the at least one intermediate page being a foldout page;
the foldout page comprises an inner page and at least one outer page;
the inner page being adjacently connected along the booklet spine; and
the at least one outer page being foldably and adjacently connected to the inner page.

5. The data-readable card integrated with re-sealable booklet as claimed in claim 1 comprises:
the front page comprises a pair of tabs and an indentation;
the pair of tabs being oppositely positioned from the booklet spine across the front page;
the pair of tabs and the booklet spine being positioned parallel to each other; and
the indentation being positioned in between the pair of tabs.

6. The data-readable card integrated with re-sealable booklet as claimed in claim 1 comprises:
the front adhesive layer being superimposed upon the front page opposite of the at least one intermediate page; and
the front protective layer being superimposed upon the front adhesive layer opposite of the front page.

7. The data-readable card integrated with re-sealable booklet as claimed in claim 1 comprises:
the data-readable card being superimposed upon the rear page opposite of the at least one intermediate page; and
the data-readable card being hingedly connected to the front adhesive layer along the booklet spine.

8. The data-readable card integrated with re-sealable booklet as claimed in claim 1 comprises:
the data-readable card comprises an integrated magnetic strip; and
the integrated magnetic strip being positioned along the data-readable card opposite of the rear page.

9. The data-readable card integrated with re-sealable booklet as claimed in claim 1 comprises:
the data-readable card comprises a micro-chip; and
the micro-chip being embedded within the data-readable card.

10. A data-readable card integrated with re-sealable booklet comprises:
a front cover;
a data-readable card;
a booklet;
the front cover comprises a front protective layer and a front adhesive layer;
the booklet comprises a front page, a rear page, at least one intermediate page, and a booklet spine;
the at least one intermediate page being positioned in between the front page and the rear page;
the front page, the at least one intermediate page, and the rear page being hingedly connected to each other by the booklet spine;
the front page comprises a pair of tabs and an indentation;
the pair of tabs being oppositely positioned from the booklet spine across the front page;
the pair of tabs and the booklet spine being positioned parallel to each other;
the indentation being positioned in between the pair of tabs;
the booklet being positioned in between the front cover and the data-readable card;
the front cover being adjacently connected across the booklet;
the data-readable card being adjacently connected across the booklet opposite of the front cover; and
the data-readable card being hingedly connected to the front cover along the booklet spine.

11. The data-readable card integrated with re-sealable booklet as claimed in claim 10 comprises:
the at least one intermediate page being a plurality of pages; and
each of the plurality of pages being adjacently connected along the booklet spine.

12. The data-readable card integrated with re-sealable booklet as claimed in claim 10 comprises:
the at least one intermediate page being a foldout page;
the foldout page comprises an inner page and at least one outer page;
the inner page being adjacently connected along the booklet spine; and
the at least one outer page being foldably and adjacently connected to the inner page.

13. The data-readable card integrated with re-sealable booklet as claimed in claim 10 comprises:
the front adhesive layer being superimposed upon the front page opposite of the at least one intermediate page; and
the front protective layer being superimposed upon the front adhesive layer opposite of the front page.

14. The data-readable card integrated with re-sealable booklet as claimed in claim 10 comprises:
the data-readable card being superimposed upon the rear page opposite of the at least one intermediate page; and
the data-readable card being hingedly connected to the front adhesive layer along the booklet spine.

15. The data-readable card integrated with re-sealable booklet as claimed in claim 10 comprises:
the data-readable card comprises an integrated magnetic strip; and
the integrated magnetic strip being positioned along the data-readable card opposite of the rear page.

16. The data-readable card integrated with re-sealable booklet as claimed in claim 10 comprises:
the data-readable card comprises a micro-chip; and
the micro-chip being embedded within the data-readable card.
